(19) United States
(12) Patent Application Publication
(10) Pub. No.: US 2026/0213317 A1
(43) Pub. Date: Jul. 23, 2026

(54) BATTERY PACK

(71) Applicant: Toyota Jidosha Kabushiki Kaisha, Toyota-shi (JP)

(72) Inventor: Naohito OGAWA, Toyota-shi (JP)

(73) Assignee: Toyota Jidosha Kabushiki Kaisha, Toyota-shi (JP)

(21) Appl. No.: 19/387,682

(22) Filed: Nov. 13, 2025

(30) Foreign Application Priority Data
Jan. 22, 2025 (JP) 2025-008925

(51) Int. Cl. H01M 50/209; H01M 50/271; H01M 50/289

(52) U.S. Cl. CPC H01M 50/209; H01M 50/271; H01M 50/289

(57) ABSTRACT

A battery pack includes: a battery module including a plurality of battery cells stacked in a predetermined stacking direction and a plurality of separators positioned between two of the battery cells adjacent to each other and sandwiching one of the battery cells in an up-down direction; and a case configured to house the battery module. The case includes: a lower support that supports the separators from below; and an upper holder that holds the separators from above.

### CROSS-REFERENCE TO RELATED APPLICATION

This application claims priority to Japanese Patent Application No. 2025-008925 filed on Jan. 22, 2025. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

Japanese Unexamined Patent Application Publication No. 2018-181746 (JP 2018-181746 A) discloses a battery pack including a plurality of battery modules and a battery case that houses the battery modules. Each battery module includes a plurality of battery cells stacked in a predetermined direction, and a module case that houses the battery cells.

### SUMMARY

The battery module of the battery pack of JP 2018-181746 A can be provided with a plurality of separators that is insulating members positioned between adjacent battery cells. When such a design change is made to JP 2018-181746 A, there is room for improvement in terms of suppressing movement of the battery cells in an up-down direction relative to the module case.

In view of the above fact, an object of the present disclosure is to provide a battery pack that can suppress movement of battery cells of a battery module in an up-down direction relative to a case.

A battery pack according to a first aspect includes: a battery module including a plurality of battery cells stacked in a predetermined stacking direction and a plurality of separators positioned between two of the battery cells adjacent to each other and sandwiching one of the battery cells in an up-down direction; and a case configured to house the battery module. The case includes: a lower support that supports the separators from below; and an upper holder that holds the separators from above.

In the battery pack according to the first aspect, the battery cells are sandwiched in the up-down direction by the separators. The case configured to house the battery module includes the lower support that supports the separators from below, and the upper holder that holds the separators from above. Therefore, the battery pack according to the first aspect can suppress movement of the battery cells of the battery module in the up-down direction relative to the case.

In a battery pack according to a second aspect, in the first aspect, the case includes: an upper case including the upper holder and a lower end opening that is positioned below the upper holder and through which the battery module is passable; and a lower case including the lower support and connected to a lower end of the upper case.

In the battery pack according to the second aspect, the battery module can be housed inside the upper case via the lower end opening of the upper case including the upper holder. When the lower case is connected to the lower end of the upper case in this state, the separators are sandwiched in the up-down direction by the upper holder of the upper case and the lower support of the lower case.

In a battery pack according to a third aspect, in the first or second aspect, when a direction orthogonal to the stacking direction in a plan view is defined as an orthogonal direction, the case includes a pair of the upper holders spaced away from each other in the orthogonal direction.

The case of the battery pack according to the third aspect includes the pair of the upper holders spaced away from each other in the orthogonal direction. Therefore, the battery pack according to the third aspect can easily suppress movement of the battery cells in the up-down direction relative to the case compared to a case where the case includes only one upper holder.

In a battery pack according to a fourth aspect, in any one of the first to third aspects, at least one of the upper holder and the lower support is elastically deformable.

In the battery pack according to the fourth aspect, at least one of the upper holder and the lower support is elastically deformable. Therefore, even if there is variation in the up-down dimensions of the separators of the battery pack according to the fourth aspect, movement of the battery cells in the up-down direction relative to the case can be suppressed.

In a battery pack according to a fifth aspect, in any one of the first to fourth aspects, the battery module includes a pair of end plates spaced away from each other in the stacking direction and sandwiching all of the battery cells and all of the separators in the stacking direction, the lower support supports the end plates from below, and the upper holder holds the end plates from above.

In the battery pack according to the fifth aspect, the upper holder and the lower support sandwich the end plates in the up-down direction. Therefore, the battery pack according to the fifth aspect can suppress movement of the battery cells in the up-down direction relative to the case.

As described above, the battery pack according to the present disclosure has the excellent effect of suppressing movement of the battery cells of the battery module in the up-down direction relative to the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery pack according to an embodiment as viewed from above;

FIG. 2 is an exploded perspective view of the battery pack as viewed from above;

FIG. 3 is a plan view of the battery pack;

FIG. 4 is a sectional view taken along line 4-4 in FIG. 3;

FIG. 5 is a sectional view taken along line 5-5 in FIG. 3;

FIG. 6 is a sectional view taken along line 6-6 in FIG. 3;

FIG. 7 is a sectional view taken along line 7-7 in FIG. 3; and

FIG. 8 is a sectional view taken along line 8-8 in FIG. 3.

### DETAILED DESCRIPTION OF EMBODIMENTS

A battery pack according to an embodiment will be described below with reference to the accompanying drawings. Arrows UP, FR, and LH in each drawing indicate an upper side in an up-down direction of a vehicle, a front side in a front-rear direction of the vehicle (stacking direction), and a left side in a right-left direction of the vehicle (orthogonal direction), respectively.

A battery pack 20 according to the present embodiment is mounted on the vehicle (electrified vehicle). The vehicle according to the present embodiment is a battery electric vehicle.

The battery pack 20 according to the present embodiment includes a case 22 and one battery module 60. Electric power of the battery pack 20 (battery cells 63) is supplied to, for example, an electric motor (not shown) that provides a driving force to drive wheels of the vehicle.

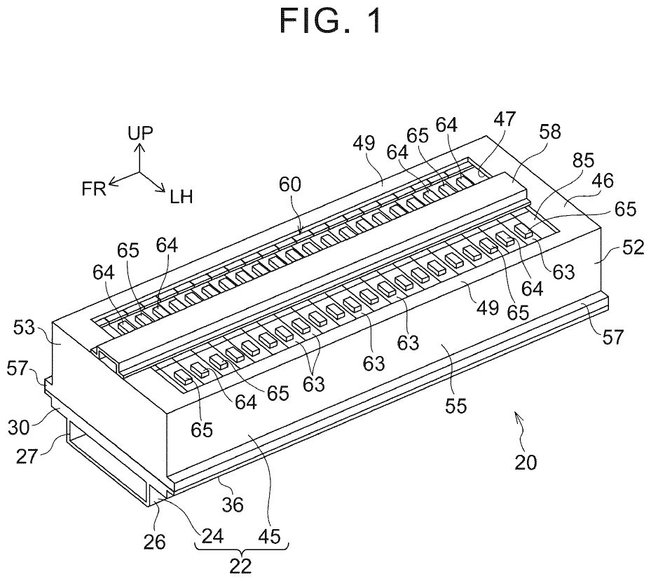

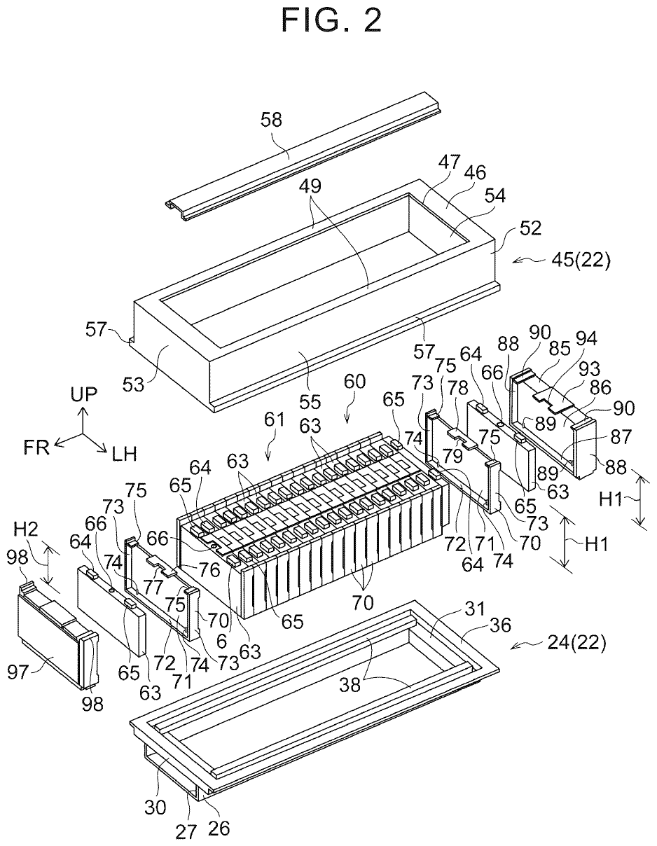

As shown in FIGS. 1 and 2, the case 22 includes a lower case 24, an upper case 45, and a smoke exhaust duct 58.

The lower case 24 is an integrally molded product obtained by aluminum die casting. The lower case 24 that is a hollow body includes a lower component 26, an upper component 30, and a connection flange 36.

As shown in FIGS. 2, 6, and 7, the upper end of the lower component 26 constituting the lower part of the lower case 24 is connected to the lower end of the upper component 30 constituting the upper part of the lower case 24. The planar shapes of both the lower component 26 and the upper component 30 are rectangles with a front-rear dimension larger than a right-left dimension. The planar shape of the upper component 30 is larger than the planar shape of the lower component 26. As shown in FIG. 2, a front end opening 27 is formed in the front end face of the lower component 26.

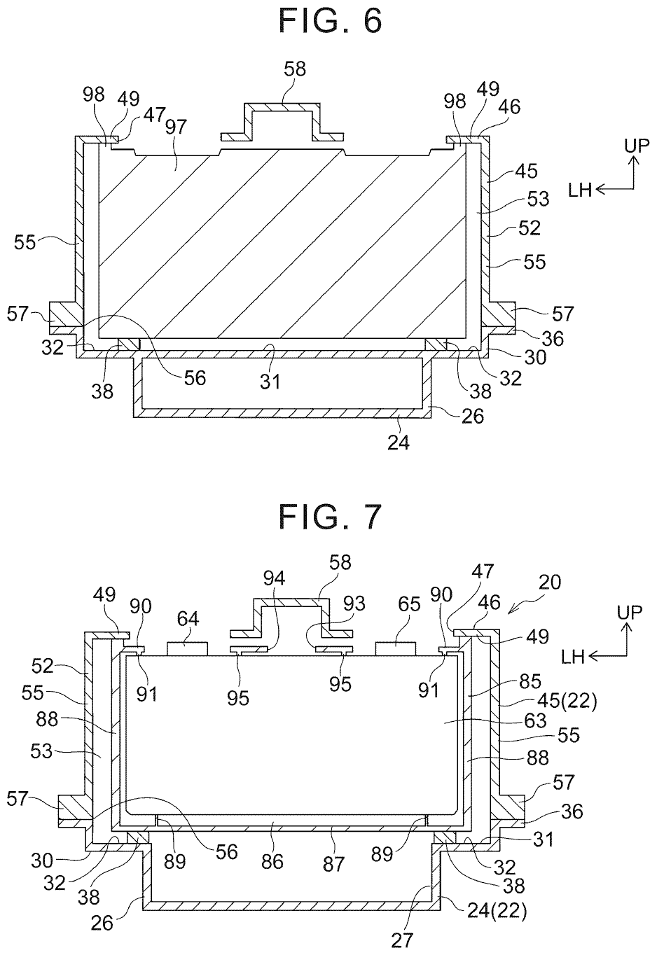

As shown in FIGS. 2 and 6, the lower end of the upper component 30 includes an annular flat surface 31 orthogonal to the up-down direction. The planar shape of the annular flat surface 31 is a rectangle with a front-rear dimension larger than a right-left dimension. The annular flat surface 31 includes a pair of right and left fixing surfaces 32 extending in the front-rear direction in a plan view. The annular connection flange 36 is provided at the upper end of the upper component 30. The planar shape of the connection flange 36 is a rectangle with a front-rear dimension larger than a right-left dimension. The upper surface of the connection flange 36 is a flat surface orthogonal to the up-down direction.

Lower supports 38 are fixed to the upper sides of the fixing surfaces 32. Each lower support 38 is a rectangular columnar member extending in the front-rear direction and has elasticity. Each lower support 38 is made of, for example, sponge. The lower support 38 is provided over the overall length of the fixing surface 32 in the front-rear direction. The bottom surface of the lower support 38 is fixed to the fixing surface 32 in an airtight manner. The front end face of the lower support 38 is fixed in an airtight manner to the front end face of the inner peripheral surface of the upper component 30. The rear end face of the lower support 38 is fixed in an airtight manner to the rear end face of the inner peripheral surface of the upper component 30.

One end of a ventilation duct (not shown) is connected to the front end opening 27 of the lower case 24. The other end of the ventilation duct is connected to a cooling fan (not shown) on the outside of the lower case 24.

The upper case 45 is an integrally molded product obtained by aluminum die casting. The upper case 45 that is a hollow body includes an upper wall 46, a peripheral wall 52, and connection flanges 57.

The planar shape of the upper wall 46 constituting the upper end of the upper case 45 is a rectangle with a front-rear dimension larger than a right-left dimension. The upper wall 46 is a flat plate orthogonal to the up-down direction. The upper wall 46 has an upper end opening 47 passing through the upper wall 46 in the up-down direction. The planar shape of the upper end opening 47 is a rectangle with a front-rear dimension larger than a right-left dimension. The right and left side portions of the upper wall 46 are upper holders 49 extending linearly in the front-rear direction in a plan view. The upper end of the peripheral wall 52 is connected to the outer peripheral edge of the upper wall 46. The annular peripheral wall 52 includes a front wall 53, a rear wall 54, and a pair of side walls 55. As shown in FIGS. 4 to 6, the thicknesses of the front wall 53 and the rear wall 54 are larger than those of the side walls 55. The front and rear ends of the left side wall 55 are connected to the left ends of the front wall 53 and the rear wall 54, respectively. The front and rear ends of the right side wall 55 are connected to the right ends of the front wall 53 and the rear wall 54, respectively. The lower surface of the peripheral wall 52 is a flat surface orthogonal to the up-down direction. In a plan view, the inner peripheral surface of the peripheral wall 52 is positioned outward of the periphery of the upper end opening 47. A lower end opening 56 is formed at the lower end of the peripheral wall 52 (see FIGS. 6 to 8). The linear connection flanges 57 extending in the front-rear direction are provided at the lower ends of the right and left sides of the outer peripheral surface of the peripheral wall 52. The lower surface of each connection flange 57 is a flat surface orthogonal to the up-down direction. The lower surface of the connection flange 57 is continuous with the lower surface of the peripheral wall 52.

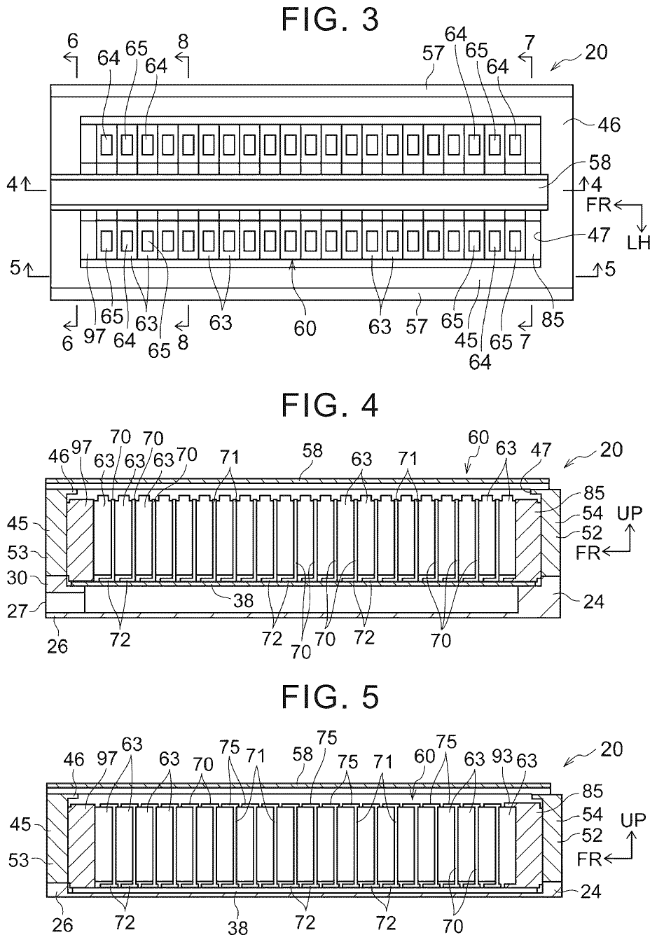

The smoke exhaust duct 58 shown in FIGS. 1 and 2 is a hollow member that is open on the front, rear, and lower sides and extends in the front-rear direction. The front-rear dimension of the smoke exhaust duct 58 is larger than the front-rear dimension of the upper end opening 47 of the upper case 45. As shown in FIGS. 1 and 3, the front end of the lower side of the smoke exhaust duct 58 is fixed to the front end of the upper wall 46 of the upper case 45, and the rear end of the lower side of the smoke exhaust duct 58 is fixed to the rear end of the upper wall 46 of the upper case 45.

As shown in FIG. 2, the battery module 60 includes a battery stack 61 and a pair of end plates 85, 97.

As shown in FIG. 2, the battery stack 61 extending in the front-rear direction in a plan view includes a plurality of battery cells 63 that is lithium ion secondary batteries, and a plurality of separators 70 that is insulating members positioned between adjacent battery cells 63.

Each battery cell 63 has a rectangular parallelepiped shape. The front shape of each battery cell 63 is a rectangle with a right-left dimension larger than an up-down dimension. A cathode terminal 64 and an anode terminal 65 are provided on the upper surface of the battery cell 63. As shown in FIGS. 2 and 3, the orientations of the battery cells 63 are set such that the cathode terminals 64 and the anode terminals 65 are arranged alternately in the front-rear direction in a plan view. A smoke exhaust portion 66 is formed on the upper surface of each battery cell 63 and is positioned between the cathode terminal 64 and the anode terminal 65. The smoke exhaust portion 66 is thinner than the surrounding area on the upper surface of the battery cell 63. That is, the mechanical strength of the smoke exhaust portion 66 is lower than the other portions than the smoke exhaust portion 66 on the upper surface of the battery cell 63. For example, when an internal short circuit occurs in the battery cell 63 and the internal pressure of the battery cell 63 reaches a predetermined value, the smoke exhaust portion 66 is ruptured. That is, the smoke exhaust portion 66 opens. When the smoke exhaust portion 66 opens, the contents (debris) inside the battery cell 63 are smoothly discharged to the outside of the battery cell 63 via the smoke exhaust portion 66. The contents include, for example, internal electrodes (current collecting terminals), an electrolyte, and gas (smoke).

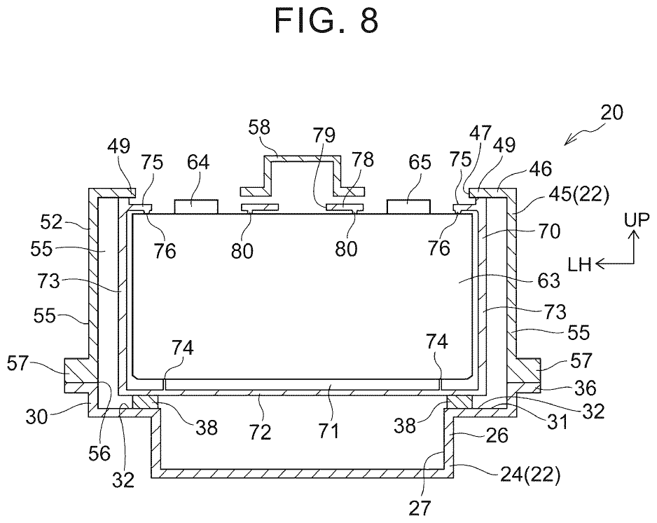

Each resin separator 70 is a hollow member having a substantially rectangular parallelepiped shape that is open on the front side. The separator 70 is an integrally molded product including a base 71, a bottom plate 72, side plates 73, elastic supports 74, retainers 75, protrusions 76, and a central holder 78. The front shape of the base 71 is a rectangle with an up-down dimension smaller than a right-left dimension. The bottom plate 72 protrudes forward from the lower edge of the base 71, and the right and left side plates 73 protrude forward from the right and left side edges of the base 71, respectively. The lower ends of the right and left side plates 73 are connected to the right and left side ends of the bottom plate 72, respectively. The upper ends of the right and left side plates 73 are positioned higher than the upper end of the base 71. A pair of right and left elastic supports 74 is provided on the upper surface of the bottom plate 72 to protrude upward (see FIGS. 2 and 8). A pair of right and left retainers 75 is provided on the right and left ends of the upper end face of the base 71 and the inner side surfaces of the right and left side plates 73. The right and left retainers 75 are flat plate-shaped portions orthogonal to the up-down direction, and their planar shape is a rectangle with a front-rear dimension larger than a right-left dimension. The right and left retainers 75 are positioned lower than the upper ends of the side plates 73. The front surfaces of the right and left retainers 75 are continuous with the front surfaces of the side plates 73. The protrusions 76 are provided on the lower surfaces of the right and left retainers 75 to protrude downward (see FIG. 8). A rear portion of the central holder 78 is fixed to the central portion of the upper end face of the base 71 in the right-left direction. The central holder 78 is a flat plate-shaped portion orthogonal to the up-down direction, and its planar shape is a rectangle with a front-rear dimension smaller than a right-left dimension. A smoke exhaust recess 79 is formed at the front edge of the central holder 78. A pair of right and left protrusions 80 is provided on the lower surface of the central holder 78 to protrude downward (see FIG. 8). The positions of the front end of the central holder 78 and the front end faces of the side plates 73 are substantially aligned in the front-rear direction. The front-rear dimensions of the portions of the bottom plate 72 and the side plates 73 that are positioned forward of the front surface of the base 71 are slightly smaller than the front-rear dimension of the battery cell 63. The right-left distance between the right and left side plates 73 is slightly larger than the right-left dimension of the battery cell 63. When the elastic supports 74, the retainers 75, the protrusions 76, the central holder 78, and the protrusions 80 are in a free state, an up-down distance H1 (see FIG. 2) between the upper end of each elastic support 74 and the lower end of each protrusion 76, 80 is smaller than an up-down dimension H2 (see FIG. 2) of the battery cell 63.

As shown in FIG. 2, the battery module 60 includes the resin end plates 85, 97. The front end plate 97 is positioned immediately in front of the foremost battery cell 63. The rear end plate 85 is positioned immediately behind the rearmost battery cell 63.

As shown in FIGS. 2, 4, 5, and 8, one battery cell 63 is provided immediately in front of each separator 70. The battery cell 63 excluding the front end is inserted into a space surrounded by the base 71, the bottom plate 72, and the side plates 73 of each separator 70. When the battery cell 63 is inserted into the space, the lower surface of the battery cell 63 is in contact with the upper ends of the right and left elastic supports 74, and the lower ends of the right and left protrusions 76 and the lower ends of the right and left protrusions 80 are in contact with the upper surface of the battery cell 63 as shown in FIG. 8. As described above, when the elastic supports 74, the retainers 75, the protrusions 76, the central holder 78, and the protrusions 80 are in a free state, the up-down distance H1 between the upper end of each elastic support 74 and the lower end of each protrusion 76, 80 is smaller than the up-down dimension H2 of the battery cell 63. Therefore, at least one of the elastic supports 74, the retainers 75 (protrusions 76), and the central holder 78 (protrusions 80) is elastically deformed by the battery cell 63. In other words, the battery cell 63 is sandwiched in the up-down direction by the elastic supports 74 and the protrusions 76, 80. Therefore, movement of the battery cell 63 in the up-down direction relative to the separator 70 is substantially restricted. As shown in FIG. 8, the inner surfaces of the right and left side plates 73 face the right and left side surfaces of the battery cell 63 with small clearances. Therefore, movement of the battery cell 63 in the right-left direction relative to the separator 70 is substantially restricted. The smoke exhaust portion 66 of the battery cell 63 is positioned directly below the smoke exhaust recess 79 of the central holder 78.

Next, the structure of the rear end plate 85 will be described. The rear end plate 85 is a resin hollow member having a substantially rectangular parallelepiped shape that is open on the front side. The end plate 85 is an integrally molded product including a base 86, a bottom plate 87, side plates 88, elastic supports 89, retainers 90, protrusions 91, and a central holder 93. The front shape of the base 86 is a rectangle with an up-down dimension smaller than a right-left dimension. The thickness (front-rear dimension) of the base 86 is larger than that of the base 71 of the separator 70. The bottom plate 87 protrudes forward from the lower edge of the base 86, and the right and left side plates 88 protrude forward from the right and left side edges of the base 86, respectively. The lower ends of the right and left side plates 88 are connected to the right and left side ends of the bottom plate 87, respectively. The upper ends of the right and left side plates 88 are positioned higher than the upper end of the base 86. A pair of right and left elastic supports 89 is provided on the upper surface of the bottom plate 87 to protrude upward (see FIGS. 2 and 7). A pair of right and left retainers 90 is provided on the right and left ends of the upper end face of the base 86 and the inner side surfaces of the right and left side plates 88. The right and left retainers 90 are flat plate-shaped portions orthogonal to the up-down direction, and their planar shape is a rectangle with a front-rear dimension larger than a right-left dimension. The right and left retainers 90 are positioned lower than the upper ends of the side plates 88. The front surfaces of the right and left retainers 90 are continuous with the front surfaces of the side plates 88. The protrusions 91 are provided on the lower surfaces of the right and left retainers 90 to protrude downward (see FIG. 7). A rear portion of the central holder 93 is fixed to the central portion of the upper end face of the base 86 in the right-left direction. The central holder 93 is a flat plate-shaped portion orthogonal to the up-down direction, and its planar shape is a rectangle with a front-rear dimension smaller than a right-left dimension. A smoke exhaust recess 94 is formed at the front edge of the central holder 93. A pair of right and left protrusions 95 is provided on the lower surface of the central holder 93 to protrude downward (see FIG. 7). The positions of the front end of the central holder 93 and the front end faces of the side plates 88 are substantially aligned in the front-rear direction. The front-rear dimensions of the portions of the bottom plate 87 and the side plates 88 that are positioned forward of the front surface of the base 86 are slightly smaller than the front-rear dimension of the battery cell 63. The right-left distance between the right and left side plates 88 is slightly larger than the right-left dimension of the battery cell 63. When the elastic supports 89, the retainers 90, and the protrusions 91 are in a free state, an up-down distance between the upper end of each elastic support 89 and the lower end of each protrusion 91, 95 is H1 (see FIG. 2).

Next, the structure of the front end plate 97 will be described. The front end plate 97 is a resin integrally molded product having a substantially rectangular parallelepiped shape. The up-down dimension and the right-left dimension of the end plate 97 are substantially the same as those of the end plate 85. The thickness (front-rear dimension) of the end plate 97 is larger than that of the base 71 of the separator 70 and smaller than that of the end plate 85. The rear surface of the end plate 97 is a flat surface. Upper end protrusions 98 are provided on the right and left ends of the upper end of the end plate 97 to protrude upward.

As shown in FIGS. 2, 4, 5, and 7, one battery cell 63 is provided immediately in front of the rear end plate 85. Most of the battery cell 63 is inserted into a space surrounded by the base 86, the bottom plate 87, and the side plates 88 of the end plate 85. When the battery cell 63 is inserted into the space, the lower surface of the battery cell 63 is in contact with the upper ends of the right and left elastic supports 89, and the lower ends of the right and left protrusions 91 and the lower ends of the right and left protrusions 95 are in contact with the upper surface of the battery cell 63. As described above, when the elastic supports 89, the retainers 90, the protrusions 91, the central holder 93, and the protrusions 95 are in a free state, the up-down distance H1 between the upper end of each elastic support 89 and the lower end of each protrusion 91, 95 is smaller than the up-down dimension H2 of the battery cell 63. Therefore, at least one of the elastic supports 89, the retainers 90 (protrusions 91), and the central holder 93 (protrusions 95) is elastically deformed by the battery cell 63. In other words, the battery cell 63 is sandwiched in the up-down direction by the elastic supports 89 and the protrusions 91, 95. Therefore, movement of the battery cell 63 in the up-down direction relative to the end plate 85 is substantially restricted. As shown in FIG. 7, the inner surfaces of the right and left side plates 88 face the right and left side surfaces of the battery cell 63 with small clearances. Therefore, movement of the battery cell 63 in the right-left direction relative to the end plate 85 is substantially restricted. The smoke exhaust portion 66 of the battery cell 63 is positioned directly below the smoke exhaust recess 94 of the central holder 93.

The front end plate 97 is positioned immediately in front of the foremost separator 70 (battery cell 63). The rear end plate 85 integrated with the battery cell 63 is positioned immediately behind the rearmost separator 70.

The battery module 60 is gripped by a gripping device (not shown) on the outside of the lower case 24 and the upper case 45 that are separated from each other. Specifically, the gripping device grips the end plates 85, 97 of the battery module 60 in the front-rear direction. As a result, the battery module 60 is slightly compressed in the front-rear direction by the gripping device. Therefore, the front surface of the battery cell 63 supported by the end plate 85 is in contact with the rear surface of the base 71 of the rearmost separator 70, and the front surface of the battery cell 63 supported by the foremost separator 70 is in contact with the rear surface of the end plate 97. The front surface of each battery cell 63 supported by each separator 70 other than the foremost separator 70 is in contact with the rear surface of the base 71 of the separator 70 positioned immediately in front of it. Adjacent separators 70 face each other in the front-rear direction with a small clearance. At this time, the front-rear dimension of the battery module 60 is slightly smaller than the front-rear dimension of the lower end opening 56 of the upper case 45. In other words, the front-rear dimension of the battery module 60 is slightly smaller than the front-rear dimension between the rear surface of the front wall 53 and the front surface of the rear wall 54. The right-left dimension of the battery module 60 is smaller than the right-left dimension of the lower end opening 56. Therefore, when the gripping device moves the battery module 60 to the position directly below the lower end opening 56 and then moves upward, the upper part of the battery module 60 is housed in the internal space of the upper case 45 via the lower end opening 56.

When the gripping device moves further upward, the upper ends of the right and left side plates 73 of each separator 70, the upper ends of the right and left side plates 88 of the end plate 85, and the upper ends of the right and left upper end protrusions 98 of the end plate 97 come into contact with the lower surfaces of the right and left upper holders 49 as shown in FIGS. 6 to 8. When the gripping device is then moved away from the battery module 60 to the position below the upper case 45, the compressive force applied to the battery module 60 by the gripping device is lost. Therefore, the front end plate 97 comes into press contact with the rear surface of the front wall 53, and the rear end plate 85 comes into press contact with the front surface of the rear wall 54. That is, reaction forces in the front-rear direction are applied to the battery module 60 from the front wall 53 and the rear wall 54. Therefore, the battery module 60 is compressed in the front-rear direction. Thus, the battery module 60 remains supported by the front wall 53 and the rear wall 54 of the upper case 45.

Next, the connection flange 36 of the lower case 24 disposed directly below the upper case 45 is brought into contact with the lower end face of the upper case 45. Therefore, as shown in FIGS. 6 to 8, the lower surface of the bottom plate 72 of each separator 70, the lower surface of the bottom plate 87 of the end plate 85, and the lower surface of the end plate 97 come into contact with the upper surfaces of the right and left lower supports 38 of the lower case 24. Thus, the lower supports 38 are elastically deformed. At this time, the upper holders 49 in contact with the side plates 73, 88 and the upper end protrusions 98 may be elastically deformed in the up-down direction. In this state, the right and left sides of the connection flange 36 of the lower case 24 and the right and left connection flanges 57 of the upper case 45 are fixed to each other using a fixing member. The fixing member includes, for example, a plurality of bolts passing through the connection flange 36 and the connection flanges 57 in the up-down direction, and a plurality of nuts screwed onto the bolts.

For example, the upper end opening 47 of the upper case 45 is used to connect a plurality of busbars (not shown) to the cathode terminals 64 and the anode terminals 65 of adjacent battery cells 63. Thus, the battery pack 20 is completed. The case 22 that houses the completed battery pack 20 is fixed to the body of the vehicle.

### Functions and Effects

Next, the functions and effects of the embodiment will be described.

As described above, in the battery pack 20 according to the present embodiment, the end plates 85, 97 of the battery module 60 are in press contact with the front wall 53 and the rear wall 54 of the upper case 45. That is, the upper case 45 supports the battery module 60 using the forces generated between the battery module 60 and the inner surface of the peripheral wall 52. The battery cells 63 are sandwiched in the up-down direction by the separators 70 and the end plate 85. Therefore, if the battery pack 20 does not have the lower supports 38 and the upper holders 49 and no external force is acting on the case 22, the battery cells 63 are less likely to move in the up-down direction relative to the separators 70 and the end plate 85.

For example, if a vehicle collision occurs and a large impact load is applied to the case 22 in the up-down direction, however, the forces generated between the battery module 60 and the inner surface of the peripheral wall 52 may be insufficient to maintain the position of each battery cell 63 relative to the case 22 (upper case 45) in the up-down direction. That is, the entire battery module 60 may be curved in an arch shape in a side view, and the heights of the upper surfaces of the battery cells 63 may vary. In particular, the reaction forces generated by the inner surface of the peripheral wall 52 are unlikely to reach a plurality of battery cells 63 (e.g., three to five battery cells 63) at the central portion of the battery module 60 in the longitudinal direction. Therefore, positional misalignment is likely to occur in the heights of the upper surfaces of the battery cells 63.

In the battery pack 20 according to the present embodiment, the separators 70 and the end plate 85 that support the battery cells 63 are sandwiched in the up-down direction by the lower supports 38 of the lower case 24 and the upper holders 49 of the upper case 45. Therefore, even if a large impact load is applied to the case 22 in the up-down direction, it is possible to reduce the case where the entire battery module 60 is curved in an arch shape in a side view and the battery cells 63 of the battery module 60 move in the up-down direction relative to the case 22. For example, the connection state between the cathode terminals 64 and the anode terminals 65 of the battery cells 63 and the busbars is less likely to become unstable. Even if a large impact load is applied to the case 22 in the up-down direction, the battery module 60 is less likely to fall off the case 22. When the battery module 60 is attached to the case 22 using the gripping device, the heights of the upper surfaces of the battery cells 63 are less likely to vary. Thus, the busbar connection work can be performed easily.

The battery module 60 can be housed inside the upper case 45 via the lower end opening 56. When the lower case 24 is connected to the lower end of the upper case 45 in this state, the battery module 60 is sandwiched in the up-down direction by the upper holders 49 of the upper case 45 and the lower supports 38 of the lower case 24. Thus, the work of attaching the battery module 60 to the case 22 is easy.

The upper case 45 includes the pair of upper holders 49 spaced away from each other in the right-left direction, and the lower case 24 includes the pair of lower supports 38 spaced away from each other in the right-left direction. Compared to a case where the upper case 45 includes only one upper holder 49 and the lower case 24 includes only one lower support 38, positional misalignment is less likely to occur in the heights of the upper surfaces of the battery cells 63.

The lower support 38 of the lower case 24 is elastically deformable. Therefore, even if there is variation in the up-down dimensions of the separators 70 of the battery pack 20, movement of the battery cells 63 in the up-down direction relative to the case 22 can be suppressed.

When the battery module 60 is supported by the lower supports 38 of the lower case 24, cooling air generated by the cooling fan and flowing into the internal space of the lower component 26 via the ventilation duct and the front end opening 27 is prevented by the lower supports 38 from leaking upward between the lower end of the battery module 60 and the annular flat surface 31. Therefore, the cooling air flowing into the internal space of the lower component 26 flows upward of the battery module 60 through the small clearances between the battery cells 63 and the separators 70, the small clearance between the end plate 85 and the battery cell 63, and the small clearance between the end plate 97 and the battery cell 63, and is discharged to the outside of the case 22 through the upper end opening 47 of the upper case 45. Therefore, the battery cells 63 can be cooled effectively by the cooling air generated by the cooling fan.

When an internal short circuit occurs in any of the battery cells 63 and the smoke exhaust portion 66 opens, the contents (debris) inside the battery cell 63 are discharged to the outside of the battery cell 63 via the smoke exhaust portion 66. In this case, for example, gas (smoke) in the contents passes through the internal passage of the smoke exhaust duct 58 and are smoothly discharged to the outside of the case 22 from at least one of the front end opening and the rear end opening of the smoke exhaust duct 58.

Although the battery pack according to the embodiment has been described above, the design can be modified as appropriate without departing from the spirit and scope of the present disclosure.

For example, the battery pack 20 need not include the smoke exhaust duct 58.

Only one of the lower support 38 and the upper holder 49 may be elastically deformable.

The lower support 38 may be made of rubber.

The lower support 38 may be manufactured as part of the lower case 24. That is, when the lower case 24 is an integrally molded product obtained by aluminum die casting, the lower support 38 is made of aluminum.

The lower case 24 may be made of resin. In this case, the lower case 24 preferably has ribs for increasing the mechanical strength of the lower case 24.

The end plates 85, 97 need not be in contact with the upper holders 49 of the upper case 45.

The stacking direction of the battery cells 63 and the separators 70 in the case 22 (extension direction of the battery module 60) may be different from the front-rear direction.

The vehicle may be an electrified vehicle that is different from a battery electric vehicle and includes an electric motor using electric power of the battery pack. For example, the vehicle may be a hybrid electric vehicle or a plug-in hybrid electric vehicle.

What is claimed is:

1. A battery pack comprising:
a battery module including a plurality of battery cells stacked in a predetermined stacking direction and a plurality of separators positioned between two of the battery cells adjacent to each other and sandwiching one of the battery cells in an up-down direction; and
a case configured to house the battery module, wherein
the case includes:
a lower support that supports the separators from below; and
an upper holder that holds the separators from above.

2. The battery pack according to claim 1, wherein the case includes:
an upper case including the upper holder and a lower end opening that is positioned below the upper holder and through which the battery module is passable; and
a lower case including the lower support and connected to a lower end of the upper case.

3. The battery pack according to claim 1, wherein when a direction orthogonal to the stacking direction in a plan view is defined as an orthogonal direction, the case includes a pair of the upper holders spaced away from each other in the orthogonal direction.

4. The battery pack according to claim 1, wherein at least one of the upper holder and the lower support is elastically deformable.

5. The battery pack according to claim 1, wherein:
the battery module includes a pair of end plates spaced away from each other in the stacking direction and sandwiching all of the battery cells and all of the separators in the stacking direction;
the lower support supports the end plates from below; and
the upper holder holds the end plates from above.
